(19) United States
(12) Patent Application Publication
(10) Pub. No.: US 2009/0141680 A1
(43) Pub. Date: Jun. 4, 2009

(54) FLEXIBLE ASSIGNMENT OF SCHEDULED AND REQUEST TRANSMISSIONS

(75) Inventor: Donald W. Becker, Rancho Santa Fe, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/276,134

(22) Filed: Nov. 21, 2008

Related U.S. Application Data
(60) Provisional application No. 60/991,632, filed on Nov. 30, 2007.

(51) Int. Cl. H04W 72/00

(52) U.S. Cl. 370/329

(57) ABSTRACT

Methods and apparatus are presented for conducting communications using a shared communication medium. A first request is sent over the shared communication medium. The shared communication medium is organized to include a signal space comprising request signal space and transmission signal space. The request signal space and the transmission signal space have different locations within the signal space. The request signal space includes request segments and the transmission signal space includes scheduled transmission segments. The first request occupies a portion of a transmission segment. An assignment is received associating the first request with a scheduled transmission segment. The assignment takes into account the location of the portion of the transmission segment within the transmission signal space. A data transmission is sent in the scheduled transmission segment associated with the first request.

### CROSS REFERENCES TO RELATED APPLICATIONS

The present application claims benefit of priority under 35 U.S.C. 119(e) of U.S. Provisional Application No. 60/991,632, Filed on Nov. 30, 2007, entitled “Flexible Assignment of Scheduled and Request Transmissions,” Attorney Docket No. 017018-017000US, Client Reference No. VS-270-US, the content of which is incorporated herein by reference in its entirety.

### BACKGROUND OF THE INVENTION

In many applications, a communication medium is shared among a number of nodes. The nodes compete with one another for access to the shared communication medium. At any given moment, there may be more than one of the nodes that wish to transmit data over the shared communication medium. A system is typically put in place to facilitate access to the shared communication medium by the various nodes. Various categories of such multiple access systems have been developed.

One category of multiple access systems utilizes contention protocols. Examples of these contention protocols include the ALOHA protocol and the slotted ALOHA protocol, which are known in the art. Here, each node is allowed to freely transmit its data over the shared communication medium at any time or any slotted time. In a system employing a hub, each node sends its transmission to the hub, which then broadcasts the transmission to all of the nodes. In a system without a hub, each node directly broadcasts its transmission to all of the nodes. In either case, every node listens to the channel for its own transmission and attempts to receive it. If a node is unsuccessful in receiving its own transmission, the node can assume that its transmission was involved in a collision with another transmission, and the node simply re-transmits its data after waiting a random amount of time. In this manner, collisions are allowed to occur but are resolved by the nodes.

Another category of multiple access systems utilizes carrier sense protocols. Examples include persistent carrier sense multiple access (persistent CSMA) and non-persistent carrier sense multiple access (non-persistent CSMA) protocols, which are known in the art. Generally speaking, these protocols require each node to listen to the shared communication medium before transmitting. Only if the shared communication medium is available is the node allowed to transmit its data. In persistent CSMA, when a node senses that the shared communication medium is not available, the node continually listens to the shared communication medium and attempts to transmit as soon as the medium becomes available. In non-persistent CSMA, when a node senses that the shared communication medium is not available, the node waits an amount of time before attempting to listen to the shared communication channel for an opportunity to transmit. Even though a node listens first before transmitting, there still exists a probability for collisions. This is because when the medium is available, two or more nodes can detect the availability and decide that they are going to transmit data. Various techniques have been developed to handle such collisions.

Yet another category of multiple access systems utilizes contention free protocols. Here, each node can reserve the shared communication medium in order to transmit data. The node can transmit data without colliding with transmissions from other nodes. This is because the shared communication medium is reserved, for a particular time duration for example, for the node's transmission and not for any other transmission. A significant advantage of contention free protocols is that the communication medium is not taken up by unsuccessful transmissions that collide with one another and the resulting re-transmission attempts. This can lead to a more efficient use of the shared communication medium, especially as the number of nodes and the number of data transmissions increase.

However, contention free protocols require a reservation process that allows nodes to reserve use of the shared communication medium. Making such reservations also requires communications. If the reservation process itself occupies too much of the shared communication medium, performance of the system can be negatively impacted. Thus, to take full advantage of the benefits of contention free protocols, more efficient systems for reservation of the shared communication medium are needed.

### SUMMARY OF THE INVENTION

An embodiment of the present invention relates to a method for communicating using a shared communication medium involving a plurality of nodes. A first request is sent over the shared communication medium from a first node in the plurality of nodes. The shared communication medium is organized to include a signal space comprising request signal space and transmission signal space. The request signal space and the transmission signal space have different locations within the signal space. The request signal space includes request segments and the transmission signal space includes transmission segments. The first request occupies a portion of a transmission segment. An assignment is received associating the first request with a transmission segment. The assignment takes into account the location of the portion of the transmission segment within the transmission signal space. From the first node, a data transmission is sent in the transmission segment associated with the first request in accordance with the assignment.

In one embodiment, the portion of the transmission segment occupied by the first request is randomly selected by the first node.

In another embodiment, the portion of the transmission segment occupied by the first request is allotted to the first node according to a schedule.

In another embodiment, a second request is sent over the shared communication medium from a second node in the plurality of nodes. The second request occupies a first request segment. The signal space is organized to include a plurality of frames. The second request occupies the first request segment in a first frame. A second assignment is received associating the second request with the request signal space of a second frame. From the second node, a second data transmission is sent in the request signal space of the second frame in accordance with the second assignment.

In another embodiment, a second request is sent over the shared communication medium from a second node in the plurality of nodes. A second assignment is received associating the second request with a second transmission segment. A second data transmission is sent in the second transmission segment associated with the second request in accordance with the second assignment.

Another embodiment of the present invention relates to an apparatus for communicating using a shared communication medium involving a plurality of nodes. A first node is capable of sending a first request over the shared communication medium. The shared communication medium is organized to include signal space comprising request signal space and transmission signal space. The request signal space and the transmission signal space have different locations within the signal space. The request signal space includes request segments and the transmission signal space includes transmission segments. The first node is capable of sending the first request in a portion of a transmission segment. The first node is capable of obtaining an assignment associating the first request with a transmission segment. The first node is capable of sending a data transmission in the scheduled transmission segment associated with the first request in accordance with the assignment.

### BRIEF DESCRIPTION OF THE DRAWINGS

FIG. 1 presents a simplified network including a scheduler node 102 and a plurality of access nodes 104, 106, 108, and 110 utilizing a shared communication medium.

FIG. 2 presents a simplified network operating under a “no scheduler mode.”

FIG. 3 depicts a time division multiplexing scheme as applied to a frequency channel having a bandwidth of 32 Hz over a duration of 1 second.

FIG. 4 depicts a frequency division multiplexing scheme as applied to a frequency channel having a bandwidth of 32 Hz over a duration of 1 second.

FIG. 5 depicts a wavelet division multiplexing scheme as applied to a frequency channel having a bandwidth of 32 Hz over a duration of 1 second.

FIG. 6 is an illustrative signal diagram showing time division multiplexing as utilized to partition the request signal space and the transmission signal space, with time division multiplexing request segments and transmission segments.

FIG. 7 is an illustrative signal diagram showing frequency division multiplexing as utilized to partition the request signal space and the transmission signal space, with frequency division multiplexing/time division multiplexing request segments and transmission segments.

FIG. 8 is an illustrative signal diagram showing time division multiplexing as utilized to partition the request signal space and the transmission signal space, with code division multiplexing request segments.

FIGS. 9A-9D are illustrative signal diagrams showing a request signal space and a transmission signal space with unoccupied request segments, occupied request segments, unscheduled transmission segments, and scheduled transmission segments, according to an embodiment of the invention.

FIG. 10 is an illustrative signal diagram showing an implementation of the flexible assignment of scheduled and request transmissions, according to an embodiment of the invention.

FIG. 11 is an illustrative signal diagram showing another implementation of the flexible assignment of scheduled and request transmissions, according to an embodiment of the invention.

The following detailed description and the accompanying drawings provide a better understanding of the nature and advantages of the present invention.

### DETAILED DESCRIPTION OF THE INVENTION

The present invention relates to communications conducted over a shared communication medium involving a plurality of nodes. The invention is specifically related to techniques employed for requesting opportunities for scheduled transmissions.

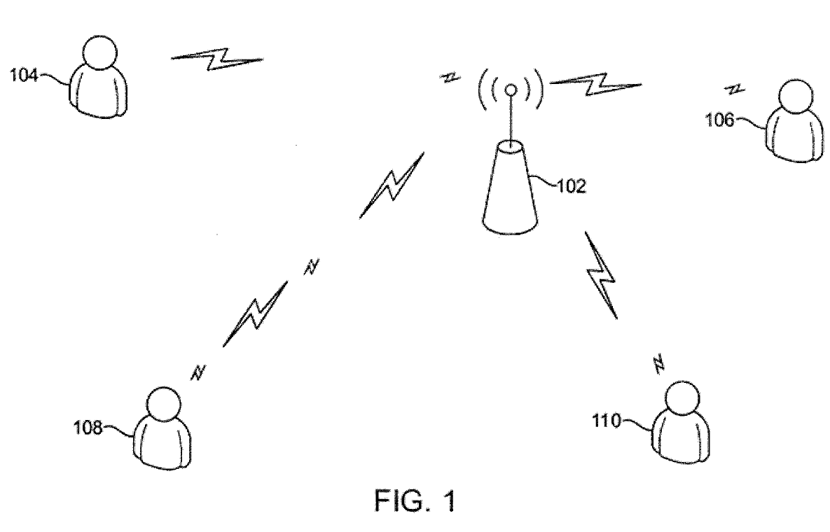

FIG. 1 presents a simplified network including a scheduler node 102 and a plurality of access nodes 104, 106, 108, and 110 utilizing a shared communication medium. This configuration corresponds to a mode of operation referred to here as “scheduler mode,” which is described as an illustrative example.

Referring to FIG. 1, scheduler node 102 serves to control usage of the shared communication medium by access nodes 104, 106, 108, and 110. The shared communication medium can represent any communication medium that may be utilized by more than one node. For example, the shared communication medium can represent signal space in one or more satellite channels. Thus, the access nodes and the scheduler node may be part of a satellite network. As another example, the shared communication medium can represent signal space in one or more wireless terrestrial channels. Thus, the access nodes and the scheduler node may be part of a terrestrial wireless network. As yet another example, the shared communication medium can represent signal space in one or more wired channels. Thus, the access nodes and scheduler node may be part of a wired network.

Furthermore, embodiments of the present invention may be implemented in different network topologies that involve a shared communication medium. These may include star topologies, mesh topologies, bus topologies, and others.

Scheduler node 102 provides control over access to the shared communication medium by access nodes 104, 106, 108, and 110. In order to transmit data over the shared communication medium, an access node, such as access nodes 104, 106, 108, and 110, first sends a request to scheduler node 102. In response, scheduler node 102 assigns an opportunity for data transmission to the access node. Scheduler node 102 sends an assignment message associated with the assignment to the access nodes. Upon receiving the assignment, the access node that made the request can transmit data in the assigned transmission opportunity. This general scheme of request, assignment, and transmission is used in various embodiments of the invention. However, other embodiments of the invention may involve variations and different operations.

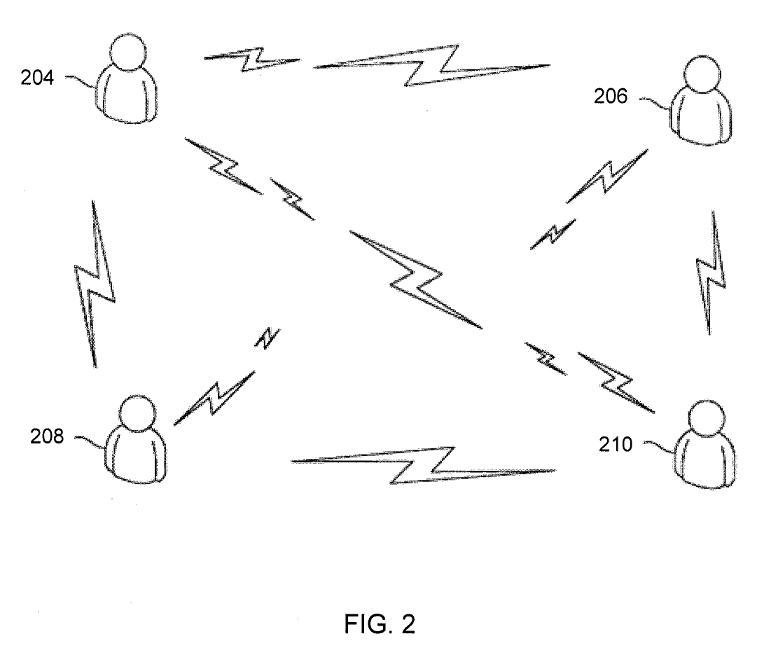

For example, FIG. 2 presents a simplified network operating under a “no scheduler mode.” A plurality of access nodes 204, 206, 208, and 210 are shown that utilize a shared communication medium. Instead of depending on a scheduler node to receive requests and determine the proper assignment of transmission segments, each access node 204, 206, 208, and 210 independently determines the proper assignment of transmission segments. Here, it is assumed that all access nodes follow the same rules for determining assignments, and all access nodes can detect all requests. If this is the case, then the same assignment of transmission segments would be generated at each access node. That is, each access node would independently generate the same assignment. As such, there would be no need for a dedicated scheduler node. Also, there would be no need for assignment messages to be sent. Each access node would be able to locally determine the proper assignment on its own. Consequently, a feedback signal space may not need to be provided for sending assignment messages.

A network may also operate under a “hybrid mode.” Referring back to FIG. 1, under a hybrid mode, each access node, such as access nodes 104, 106, 108, and 110, receives both (1) assignment messages from a scheduler node such as scheduler node 102 and (2) requests from the other access nodes. Here, each access node independently determines the proper assignment of transmission segments based on requests received from other nodes. However, in making the determination, the access node also takes into account the assignment messages received from the scheduler node. By utilizing both sources of information, each access node can make a more robust determination regarding the proper assignment of transmission segments.

Alternatively, a system may contain a mixture of access nodes operating under different assignment modes. Some of the access nodes in the system may operate under a “scheduler mode.” Some of the access nodes in the system may operate under a “no scheduler mode.” Finally, some of the access nodes in the system may operate under a “hybrid mode.”

### Symbols

Generally speaking, a basic unit of data transmission is referred to here as a “symbol.” A symbol can be defined to have one out of a number of possible values. For example, a binary symbol may have one of two possible values, such as “0” and “1.” Thus, a sequence of N binary symbols may convey 2^{N} possible messages. More generally speaking, an M-ary symbol may have M possible values. Thus, a sequence of N M-ary symbols may convey M^{N} possible messages.

The concept of symbol and the methods by which a symbol can assume values is quite general. In many applications, a symbol is associated with a defined baseband pulse shape which is up-converted to a carrier frequency with a particular phase relationship to the carrier and with a particular amplitude. The amplitude and/or phase of the symbol is known as the modulation and carries the information of a symbol. The set of permissible modulation points defined in the amplitude and phase plane is known as the modulation constellation. The amount of information that a symbol may convey is related to the number of discrete points of the constellation. 16-QAM is an example of an amplitude-phase constellation which allows transmission of up to 4 bits of information per symbol. In some applications, only the phase is used for modulation. Quadra-phase shift keying (QPSK) is an example of pure phase modulation which allows transmission of up to 2 bits of information per symbol. In other applications, the symbol waveform may be defined such that symbol phase may either not exist or be difficult to receive accurately, in which case pure amplitude modulation can be used. One example of binary amplitude modulation is on-off amplitude-shift keying modulation which allows transmission of up to 1 bit of information per symbol.

Each symbol may occupy a particular portion of the relevant signal space. Specifically, each symbol may be said to occupy a certain amount of “time-bandwidth product.” Here, an amount of time-bandwidth product is a scalar quantity that may be measured in units of Hz-seconds and does not necessarily dictate how the signal is distributed within the signal space. In theory, symbols cannot be strictly limited in both time and frequency. It is customary, however, to define the time-bandwidth product of a signal to be the time-bandwidth product of the region in which the preponderance of signal energy resides. Since precise definitions of time-bandwidth product vary somewhat throughout the literature, figures showing symbol boundaries in time-frequency space should only be considered as approximate representations.

Just as a simple example, a signal spanning a bandwidth of 1 Hz and lasting a duration of 1 second may have a time-bandwidth product of 1 Hz-second. A signal spanning a bandwidth of 0.5 Hz and lasting a duration of 2 seconds may also have a time-bandwidth product of 1 Hz-second. Similarly, a signal spanning a bandwidth of 0.1 Hz and lasting a duration of 10 seconds may also have a time-bandwidth product of 1 Hz-second. These examples do not assume any multiplexing of the signal space, which is discussed separately below. Also, the particular values used in these and other examples described herein are for illustrative purpose only. Different values may be used in actual systems.

The measurement of a symbol in terms of an amount of time-bandwidth product is also applicable when different signal space multiplexing techniques are employed. Such techniques may include time-division multiplexing, frequency-division multiplexing, wavelet-division multiplexing, code-division multiplexing, and others. In each of the following four examples, a symbol occupies a time-bandwidth product of 1 Hz-second, even though different signal space multiplexing techniques are used.

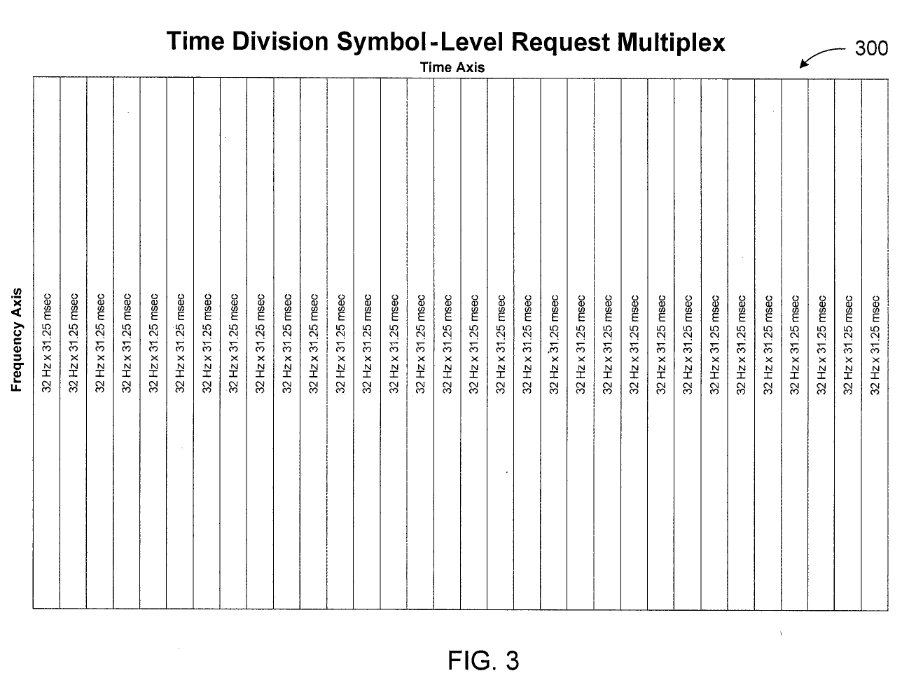

In a first example, FIG. 3 depicts a time division multiplexing scheme 300 as applied to a frequency channel having a bandwidth of 32 Hz over a duration of 1 second. The channel is divided into 32 time slots, each having a duration of 1/32 second. A symbol may be transmitted in each 1/32-second time slot over the bandwidth of 32 Hz. In this example, each symbol has a time-bandwidth product of 1 Hz-second.

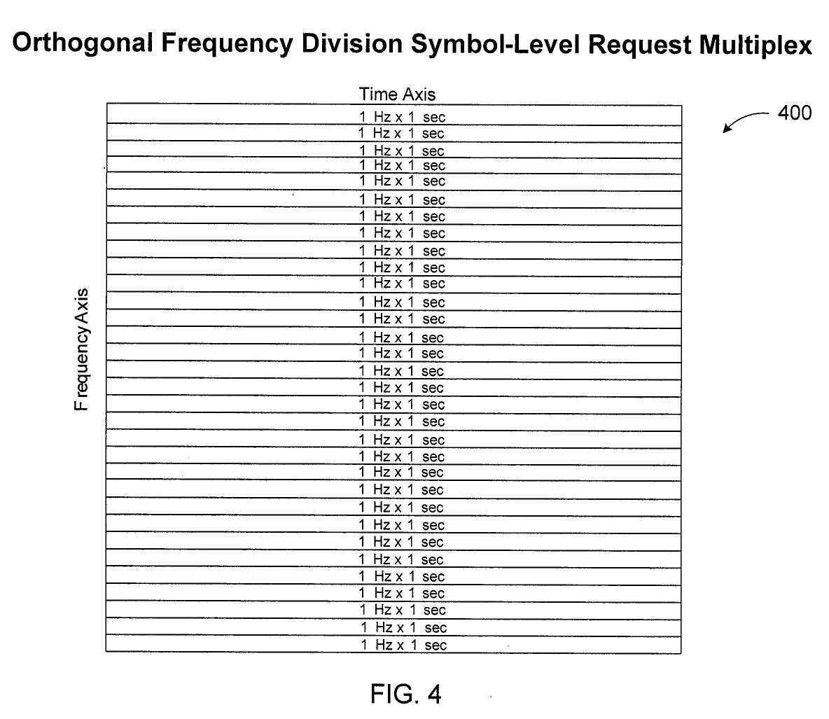

In a second example, FIG. 4 depicts a frequency division multiplexing scheme 400 as applied to a frequency channel having a bandwidth of 32 Hz over a duration of 1 second. The channel is divided into 32 different frequency sub-channels each having a bandwidth of 1 Hz. A symbol may be transmitted in each 1 Hz frequency sub-channel over a duration of 1 second. In this example, each symbol also has a time-bandwidth product of 1 Hz-second.

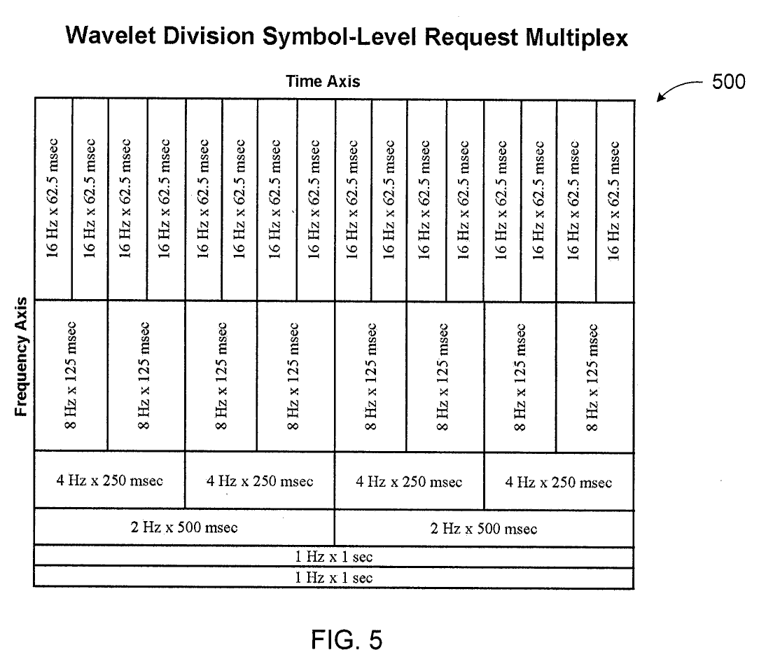

In a third example, FIG. 5 depicts a wavelet division multiplexing scheme 500 as applied to a frequency channel having a bandwidth of 32 Hz over a duration of 1 second. The channel is divided into 32 different time and frequency symbol segments. 2 symbol segments have a bandwidth of 1 Hz with a duration of 1 second, 2 other symbol segments have a bandwidth of 2 Hz with a duration of ½ second, 4 other symbol segments have a bandwidth of 4 Hz with a duration of ¼ second, 8 other symbol segments have a bandwidth of 8 Hz with a duration of ⅛ second, and 16 additional symbol segments have a bandwidth of 16 Hz with a duration of 1/16 second. In this example, each symbol has a time-bandwidth product of 1 Hz-second.

In a fourth example, a code-division multiplexing scheme is applied to a frequency channel having a bandwidth of 32 Hz over a duration of 1 second. For this example, it is assumed that there are 32 different possible orthogonal code words, each comprising a unique 32-chip binary pattern. Each code word represents a unique “code channel.” To send a symbol on a particular code channel, the symbol value is used to modulate the code word associated with the code channel, and the resulting signal is sent. In the case of binary phase shift keying (BPSK) symbols, for instance, a symbol having a value of “1” may be sent by simply sending the code word, and a symbol having a value of “0” may be sent by sending the inverted version (180-degree phase shift) of the code word. The 32 symbols sent using 32 different “code channels” are non-interfering, and as a group they occupy a common 32 Hz by 1 second portion of the time-frequency space. In this example, each symbol has an effective time-bandwidth product of 1 Hz-second.

### Symbol-Level Request

Referring back to FIG. 1, a symbol-level request may be sent from an access node such as access nodes 104, 106, 108, and 110. Here, a symbol-level request refers to a request that can be sent in the form of a transmission signal having a time-bandwidth product comparable to that of a symbol. For example, a symbol-level request may occupy exactly one symbol. Thus, a protocol message comprising a large number of symbols, representing a header and a data payload that must be processed and interpreted, would not be considered a symbol-level request.

The use of a symbol-level request allows for highly efficient utilization of the available signal space. Because of its compact size, a symbol-level request may not have sufficient capacity to carry a significant data payload. However, information may be conveyed in the choice of the location within the request signal space in which the symbol-level request is transmitted. Thus, the existence of a symbol-level request in the request signal space, as well as the location where the symbol-level request exists in the request signal space, can convey important information that is used to facilitate the assignment of transmission opportunities within the shared communication medium.

### Request Signal Space and Transmission Signal Space

The shared communication medium utilized by access nodes 104, 106, 108, and 110 may be organized into a request signal space and a transmission signal space. Just as an example, the shared communication medium may be implemented as a satellite “return-link” that allows signals to be sent from access nodes 104, 106, 108, and 110 to scheduler node 102.

The request signal space may be used by access nodes 104, 106, 108, and 110 to send requests—e.g., symbol-level requests—to request opportunities for the scheduled transmission of data. Specifically, the request signal space may be organized into a plurality of request segments. Each request segment generally refers to a portion of request signal space that may be used for sending a request.

The transmission signal space may be used by access nodes 104, 106, 108, and 110 to transmit data once requests for transmission have been granted. The transmission signal space may be organized into a plurality of transmission segments. Each transmission segment generally refers to a portion of the transmission signal space that may be used for sending a data transmission.

The request signal space, as well as the transmission signal space, may be organized based on various multiplexing techniques. Thus, the plurality of request segments in the request signal space may represent allotments defined based on one or more types of multiplexing techniques applied to the request signal space. As mentioned previously, these may include time division multiplexing, frequency division multiplexing, wavelet division multiplexing, code division multiplexing, and other multiplexing techniques. Similarly, the plurality of transmission segments in the transmission signal space may represent allotments defined based on one or more types of multiplexing techniques applied to the transmission signal space.

As such, each request segment may have a different “location” within the request signal space. For example, if a request signal space is organized according to a time division multiplexing technique, each request segment may comprise a different time slot in the request signal space. Here, each particular request segment is said to correspond to a different location (in time) in the request signal space. The same concept can be applied to a request signal space organized according to a frequency division multiplexing technique. In such a case, each request segment may comprise a particular frequency sub-channel and be said to correspond to a different location (in frequency) in the request signal space. The same concept can be applied to a request signal space organized according to a code division multiplexing technique. In such a case, each request segment may comprise a particular code word and be said to correspond to a different location (in code space) in the request signal space. Similarly, the concept can be applied to a request signal space organized according to a combination of different multiplexing techniques, such as a combination of time division multiplexing and frequency division multiplexing techniques. In this particular example, each request segment may comprise a particular time slot in a particular frequency sub-channel and be said to correspond to a different location (in time and frequency) in the request signal space.

Also, the separation between the request signal space and the transmission signal space may be based on different multiplexing techniques. In one embodiment, time division multiplexing is employed. For example, the request signal space and the transmission signal space may be defined over different time slots and a common frequency range. In another embodiment, frequency division multiplexing is employed. For example, the request signal space and the transmission signal space may be defined over a common time duration and different frequency ranges. In yet another embodiment, code division multiplexing is employed. For example, the request signal space and the transmission signal space may be defined over a common time duration and a common frequency range, but use different code words. Other embodiments of the invention may involve different combinations and/or variations.

### Feedback Signal Space

A feedback signal space may be utilized for sending the assignment messages from scheduler node 102 to access nodes 104, 106, 108, and 110. In some embodiments of the invention, the feedback space is not a part of the shared communication medium. Continuing with a satellite system example, the feedback signal space may be implemented as a satellite “forward-link” that allows signals to be sent from scheduler node 102 to access nodes 104, 106, 108, and 110. This satellite “forward-link” may be separate from the “return-link” mentioned previously.

The present invention broadly covers different combinations of multiplexing techniques as applied to the request signal space and the transmission signal space. In the figures discussed below, a number of examples of such multiplexing combinations are presented. The various combinations of multiplexing techniques described below are presented for illustrative purposes and are not intended to restrict the scope of the invention. In some examples, a feedback signal space is also explicitly shown along with the request signal space and the transmission signal space.

In the figures below, only a representative portion of the relevant signal space is shown. For example, if four frames of signals are shown, it should be understood that more frames may be used even though they are not explicitly illustrated. Also, the particular sizes and proportions of the various signal space designs are provided as mere examples.

Time Division Multiplexing Request Signal Space and Transmission Signal Space Partitioning with Time Division Multiplexing Request Segments and Transmission Segments

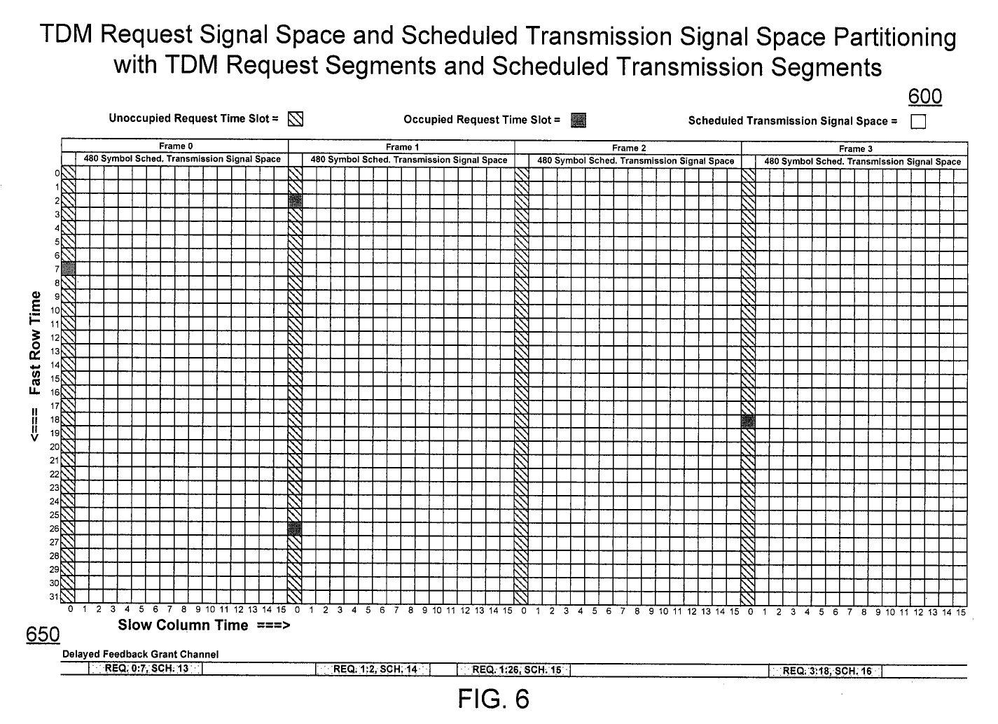

FIG. 6 is an illustrative signal diagram showing time division multiplexing (TDM) as utilized to partition the request signal space and the transmission signal space, with TDM request segments and transmission segments. The figure shows a representation of shared communication medium 600 that includes a request signal space and a transmission signal space. Separately, the figure shows a feedback signal space 650.

In this particular example, the shared communication medium 600 is organized as one continuous sequence of TDM time slots. For example, the shared communication medium 600 may comprise a particular frequency channel. Each TDM time slot occupies the entire bandwidth of the frequency channel, but only for a specific time duration. Here, the TDM time slots are shown as being organized into “frames,” such as Frame 0, Frame 1, Frame 2, and Frame 3. For ease of illustration, FIG. 6 presents the TDM time slots in multiple columns, instead of one continuous column. Nevertheless, it should be understood that the TDM time slots represent a single sequence of time slots that are transmitted sequentially.

For example, FIG. 6 shows that Frame 0 includes 512 TDM time slots. These 512 TDM time slots are shown as being arranged in a rectangular grid having 16 columns (Column 0 through Column 15) and 32 rows (Row 0 through Row 31). The sequence of TDM time slots is arranged in time as follows. Slots 0 through 31 of Column 0, followed by Slots 0 through 31 of Column 1, followed by Slots 0 through 31 of Column 2, and so on. In this manner, the entire sequence of 512 time slots in Frame 0 is arranged sequentially in time. Frame 1 is structured similarly and follows Frame 0. That is, the last time slot of Frame 0 is followed by the first slot of Frame 1. Frame 2 is structured similarly and follows Frame 1. Frame 3 is structure similarly and follows Frame 2, and so on. Thus, the entire sequence of TDM time slots contained in all the frames, including Frames 0, 1, 2, and 3, is arranged sequentially in time.

In the particular grid representation shown in FIG. 6, time can be seen as proceeding down each column of TDM time slots. Hence the direction down each column, across multiple rows, is labeled as “Fast Row Time.” Only after proceeding through all the TDM time slots in a column can the next column be started. Thus, it takes longer to proceed from one column to the next. Hence the direction across multiple columns is labeled as “Slow Column Time.”

In FIG. 6, the request signal space and transmission signal space are defined on the basis of these TDM time slots. Thus, in this example, the request signal space and the transmission signal space are separated using TDM multiplexing. Here, each frame includes a number of request segments and a single transmission segment. In Frame 0, for example, the first 32 time slots are considered 32 request segments (Column 0). The next 480 time slots are considered one transmission segment, made up of 480 symbols (Columns 1 to 15). Other frames, such as Frames 1, 2, and 3, are structured in a similar manner.

FIG. 6 shows the following types of signal allotments: (1) Unoccupied Request Time Slots, (2) Occupied Request Time Slots, and (3) Transmission Segments. In this example, only some of the available request segments are occupied by actual requests sent from one or more access nodes. Thus, some request segments are shown as unoccupied request slots, and others are shown as occupied request slots. Each transmission segment is shown as including a number of symbols, referred to as transmission data symbols.

When an access node, such as access nodes 104, 106, 108, and 110, needs to request a scheduled transmission it sends out a request in one of the request segments. Here, it is assumed that a TDM system is implemented in which all of the nodes are time-synchronized, such that every node has the capability to send signals in the appropriate time slots. Of course, in practice signals sent from various nodes may not arrive in their respective time slots with perfect timing accuracy. The TDM system may be designed to handle such imperfections, up to certain tolerances.

In one example, the request signals shown in FIG. 6 may be sent as follows. Node 104 may send a request in Slot 7 of the request signal space (Column 0) in Frame 0. Node 106 may send a request in Slot 2 of the request signal space (Column 0) in Frame 1. Node 108 may send a request in Slot 26 of the request signal space (Column 0) in Frame 1. Finally, node 110 may send a request in Slot 18 of the request signal space (Column 0) in Frame 3. Again, access nodes 104, 106, 108, and 110 are shown in FIG. 1. Of course, an access node may also send multiple requests, sometimes in the same frame. Thus, in an alternative example, all four of the requests shown in FIG. 6 may be sent from access node 104. That is, access node 104 may send the request in Slot 7 of the request signal space (Column 0) in Frame 0, the requests in Slot 2 and Slot 26 of the request signal space (Column 0) in Frame 1, and the request in Slot 18 of the request signal space (Column 0) in Frame 3.

Scheduler node 102 shown in FIG. 1 receives the requests and makes assignments to assign each request to a transmission segment. Thus, in response to the requests, scheduler node 102 sends out assignment messages in a feedback signal space 650. The assignment messages are broadcast to access nodes 104, 106, 108, and 110 to inform the access nodes of the assignments made, so that each access node may correctly send data in the assigned transmission segment.

FIG. 6 depicts an assignment message under a “robust first in, first out schedule mode.” In this mode, each assignment message explicitly includes a pair of data: (1) an identifier for the request and (2) an identifier for the transmission segment associated with the request. In other words, the pairing of a request to an associated transmission segment is directly stated in the assignment message. For example, as shown in FIG. 6, the first assignment message includes the pair of data “REQ. 0:7, SCH. 13.” This indicates that the request sent in the request segment known as “REQ. 0:7” (the request segment located at Frame 0, Slot 7) has been assigned the transmission segment known as “SCH. 13” (the transmission segment located in Frame 13). The rest of the assignment messages follow a similar format. The second assignment message includes the pair of data “REQ. 1:2, SCH. 14.” The third assignment message includes the pair of data “REQ. 1:26, SCH. 15.” The fourth assignment message includes the pair of data “REQ. 3:18, SCH. 16.”

The entire request and assignment process may take place in an anonymous manner with respect to the identity of the access nodes. Thus, a symbol-level request sent from an access node does not explicitly identify the access node. For example, assume that access node 104 sent the symbol-level request “REQ. 0:7” (Slot 7 of the request signal space of Frame 0). This symbol-level request is merely a symbol transmitted at a particular location within the request signal space. The symbol-level request does not explicitly identify access node 104. Similarly, the corresponding assignment message “REQ. 0:7, SCH. 13” broadcast from scheduler node 102 does not explicitly identify access node 104 as the intended recipient of the assignment message. Instead, the assignment message merely announces that the symbol-level request sent in the “REQ. 0:7” slot has been assigned to the transmission segment “SCH. 13.” All of the access nodes 104, 106, 108, and 110 receive the broadcast assignment message. However, only access node 104 accepts the assignment and proceeds to send a data transmission in the transmission segment identified by the assignment. This is possible because each access node keeps track of the locations of the symbol-level requests it has sent. Access node 104 recognizes the request “REQ 0:7” identified in the assignment as one of its own and thus accepts the assignment. The other access nodes 106, 108, and 110 do not recognize the request “REQ. 0:7” identified in the assignment as one of their own and thus do not accept the assignment.

In FIG. 6, the feedback signal space 650 is labeled as “Delayed Feedback Grant Channel.” An assignment message sent in feedback signal space 650 may be delayed in the sense that it may not be received until some time after (perhaps multiple frames after) the initial request is made.

Frequency Division Multiplexing Request Signal Space and Transmission Signal Space Partitioning with Frequency Division Multiplexing/Time Division Multiplexing Request Segments and Transmission Segments

FIG. 7 is an illustrative signal diagram showing frequency division multiplexing (FDM) as utilized to partition the request signal space and the transmission signal space, with FDM/TDM request segments and transmission segments. The figure shows a representation of a shared communication medium 700 based on an FDM structure that includes a request signal space and a transmission signal space. The request signal space comprises a narrow FDM frequency channel labeled as Request Channel. The transmission signal space comprises two wide FDM frequency channels labeled as Transmission Channel 1 and Transmission Channel 2. A feedback signal space is not explicitly shown in this figure but may be implemented in a manner similar to that described with respect to FIG. 6.

This example demonstrates that the request signal space and the transmission signal space may have very different symbol structures. In the request signal space, a symbol is transmitted over a narrow channel with a longer time duration. These are labeled as Request Slots 0, 1, 2, 3, etc. in the figure. By contrast, in the transmission signal space, a symbol is transmitted over one of the two wide channels with a shorter time duration. These are labeled as Data Transmission Indices 0, 1, 2, 3, . . . , 63 in the figure. Despite this difference in symbol structures, a symbol transmitted in the request signal space may have the same time-bandwidth product as a symbol transmitted in the transmission signal space. Thus, FIG. 7 presents request segments based on FDM and TDM, as well as transmission segments based on FDM and TDM.

FIG. 7 shows the following types of signal allotments: (1) Unoccupied Request Slots and (2) Occupied Request Slots. In this example, only one of the available request segments is occupied by an actual request sent from one of the access nodes. Thus, all of the request segments are shown as unoccupied request slots except one request segment that is shown as an occupied request slot. FIG. 7 also shows transmission segments. Each transmission segment comprises a block of N data symbols referred to here as a data transmission segment.

FIG. 7 presents an illustrative request as sent from one or more access nodes, such as access nodes 104, 106, 108, and 110. The request shown is sent in Slot 1 of the request signal space. In response, scheduler node 102 broadcasts an assignment message in feedback signal space (not shown). The assignment message is broadcast to access nodes 104, 106, 108, and 110 to inform the access nodes of the assignment made, so that each access node may correctly send data in the assigned transmission segments.

Also shown in FIG. 7 are guard zones, specifically, frequency guard bands positioned between various channels. A first frequency guard band is positioned between Transmission Channel 1 and the Request Channel. A second frequency guard band is positioned between the Request Channel and Transmission Channel 2. The use of these guard bands can improve reception and processing of a signal on a particular carrier by providing separation and reduced interference from neighboring carriers.

Time Division Multiplexing Request Signal Space and Transmission Signal Space Partitioning with Code Division Multiplexing Request Segments

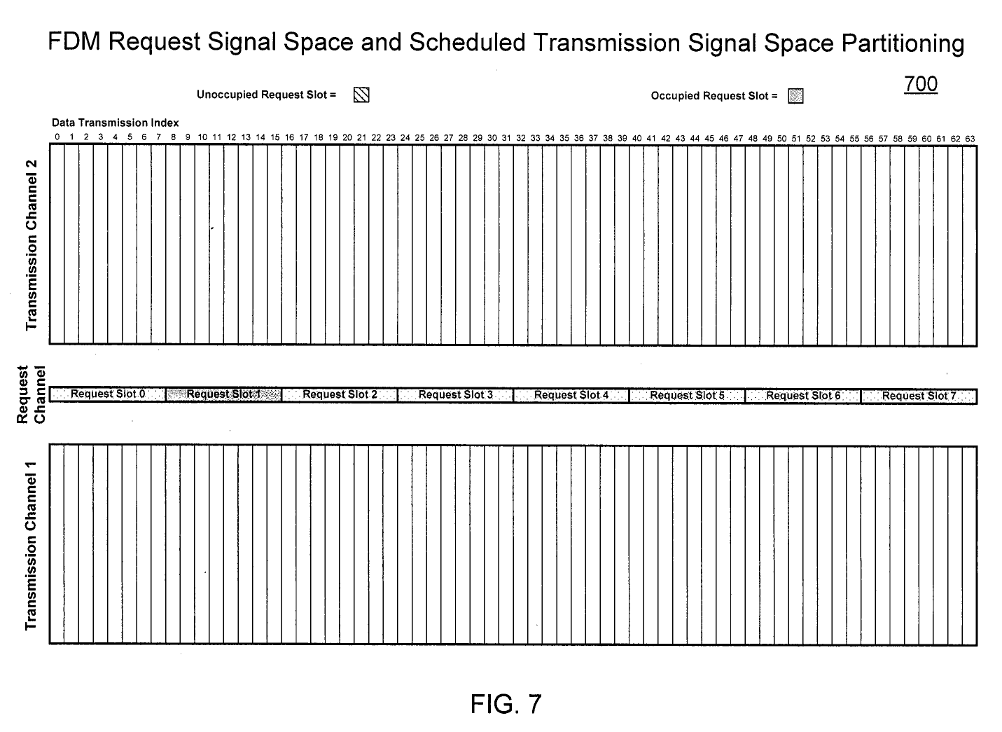

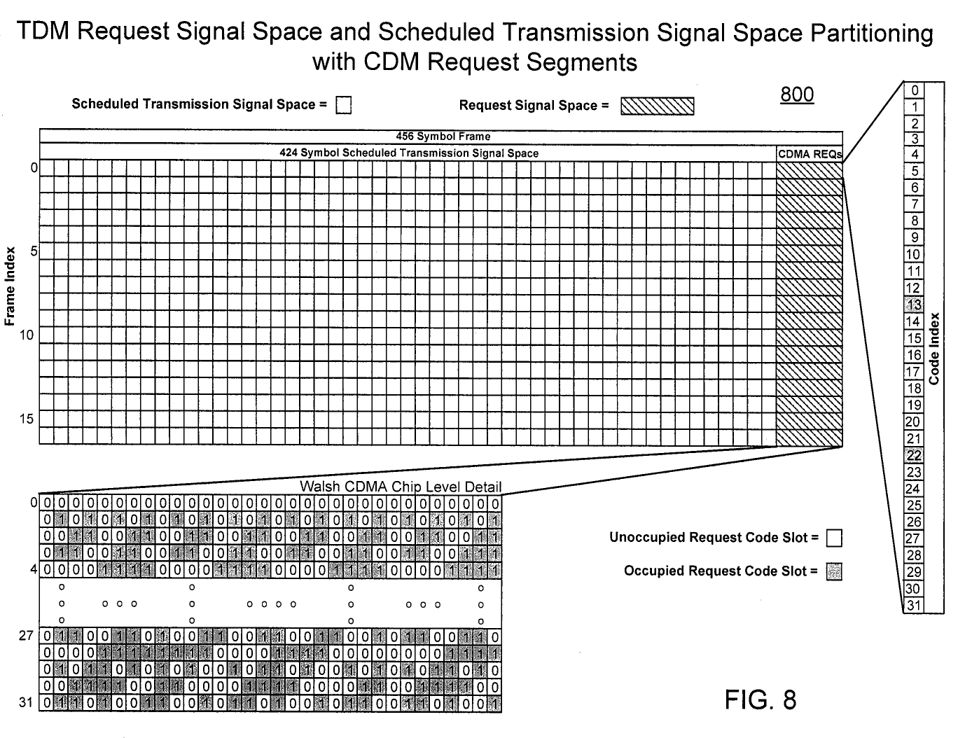

FIG. 8 is an illustrative signal diagram showing TDM as utilized to partition the request signal space and the transmission signal space, with code division multiplexing (CDM) request segments. The figure shows a representation of a shared communication medium 800 based on a TDM structure that includes a request signal space and a transmission signal space. A feedback signal space is not explicitly shown in this figure but may be implemented.

In the example shown in FIG. 8, the structure is based on sequentially ordered frames. Seventeen such frames are shown in this figure, labeled by frame indices 0 through 16. Additional frames may follow. In this example, each frame has a total length of 456 symbols. This total length is divided between a transmission signal space portion having a length of 424 symbols and a request signal space portion having a length of 32 symbols.

For ease of illustration, the numerous symbols are not individually shown in this figure. Instead, boxes representing multiple symbols are shown. In the transmission signal space, each short box represents 8 transmission symbols. In the request signal space, each long box represents a 32-chip CDM request interval. Although the signal segments representing individual chips of any particular CDM code may be similar in design to the signal segments representing the transmission symbols, the chips of any particular code are linked in a particular code pattern (e.g., a 32-chip pattern), whereas the transmission symbols may be individually modulated. As shown, FIG. 8 presents transmission segments based on TDM and request segments based on CDM.

More specifically, in this example each 456-symbol frame supports 1 transmission segment and 32 request segments. The 1 transmission segment comprises the first 424 symbols of the frame. The 32 request segments comprise the 32 possible code words that may be transmitted in the remaining portion of the frame. In other words, the remaining portion of the frame is code division multiplexed and organized as a 32-chip request interval.

Here, a 32-chip Walsh CDMA code is shown. In this code space there exists 32 different code words each having a length of 32 chips. Indices 0 through 31 are used to identify the 32 different code words. FIG. 8 shows a portion of the chip-level detail of the 32 code words. Other types and lengths of code may be used in accordance with embodiments of the invention.

One or more of the access nodes 104, 106, 108, and 110 can send one or more requests (each in the form of one of the 32 possible code words) in a particular request interval. This is illustrated in FIG. 8. In the example shown, two requests are sent in the request interval of Frame 0. The first request is a signal spread according to code word 13. The second request is a signal spread according to code word 22. Thus, in this example, CDM allows each request interval to support 32 request segments, i.e., codes slots. As shown in FIG. 8, two of these request segments are occupied. The remaining thirty request segments are unoccupied.

Scheduler node 102 detects reservation requests by correlation over the request interval against all reservation request codes. Scheduler node 102 broadcasts assignment messages in feedback signal space (not shown). The assignment messages are broadcast to access nodes 104, 106, 108, and 110 to inform the access nodes of the assignments made, so that each access node may correctly send data in the assigned transmission segment.

The entire request and assignment process may take place in an anonymous manner with respect to the identity of the access nodes. Thus, a symbol-level request sent from an access node does not explicitly identify the access node. For example, assume that access node 104 sends the symbol-level request comprising code word 13. This symbol-level request is merely a signal transmitted at a particular code location within the request signal space. The symbol-level request does not explicitly identify access node 104.

Similarly, the corresponding assignment message would not explicitly identify access node 104 as the intended recipient of the assignment message. Instead, the assignment message merely announces that the symbol-level request corresponding to code word 13 in Frame 0 has been assigned to a particular transmission segment. All of the access nodes 104, 106, 108, and 110 receive the broadcast assignment message. However, only access node 104 accepts the assignment and proceeds to send a data transmission in the transmission segment identified by the assignment. This is possible because each access node keeps track of the locations in code space of the symbol-level requests it has sent in each frame. Access node 104 recognizes the request identified in the assignment as one of its own and thus accepts the assignment. The other access nodes 106, 108, and 110 do not recognize the request identified in the assignment as one of their own and thus do not accept the assignment.

### Default Assignment of Transmission Segments

In any of the previous examples, the transmission signal space may comprise a plurality of transmission segments in each frame that include at least one default use segment available for use by a default node or a plurality of default nodes. Default use segments may include those transmission segments not assigned to any symbol-level request. Such a technique allows for a flexible use of transmission segments that do not become assigned as a result of a specific symbol-level request.

In one implementation, a two-tier assignment technique is employed. The first tier is a “priority tier” of assignments. This may comprise an assignment associating a symbol-level request with a transmission segment, as discussed in prior sections of the present disclosure. A second tier is a “space available” tier of assignments. In this tier, one or more transmission segments are assigned to a default entity. The default entity is given conditional use of these transmission segments. The condition is that, if the transmission segments are not assigned in the priority tier (thus they are available), the default entity may use the transmission segments. In other words, the second tier allows for secondary assignments of transmission segments.

Each of these second-tier assignments may be specified for a particular time duration. The second-tier assignments may partition the transmission signal space in a different way than the first tier of assignments.

The default entity may comprises a default node. Here, the default node enjoys use of the one or more transmission segments if they are not assigned in the first tier. The default node may use the transmission segments to perform file transfers, certain low priority data flows, etc.

Alternatively, the default entity may comprise a group of default nodes. Here, the group of default nodes share the default use of the one or more transmission segments. The transmission segments may be allocated as a block of the signal space. The group of default nodes may share the default use of the block on a contention basis. For example, each member of the group of default nodes may compete with the other members for the right to use the entire block or portions of the block of signal space. Various contention access protocols may be implemented, such as Slotted Aloha and others.

In yet other implementations, the default entity is selected from a plurality of default entities including at least one default node and at least one group of default nodes. Thus, in this system the second tier may include a mix of default nodes and groups of default nodes. A particular second-tier assignment may assign the default use of a block of signal space to a default node or to a group of default nodes.

### Flexible Assignment of Scheduled and Request Transmissions

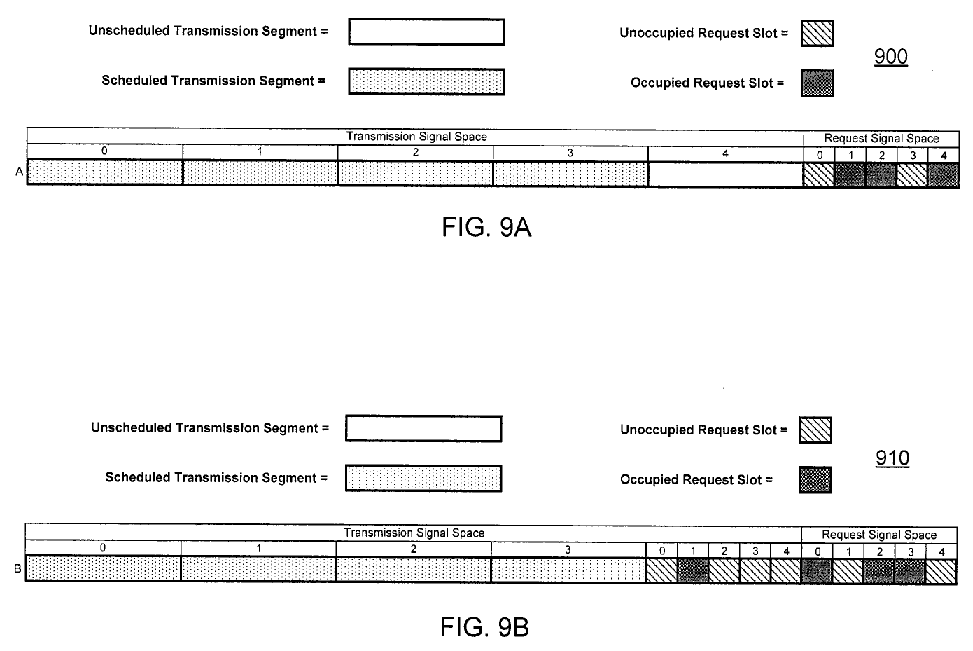

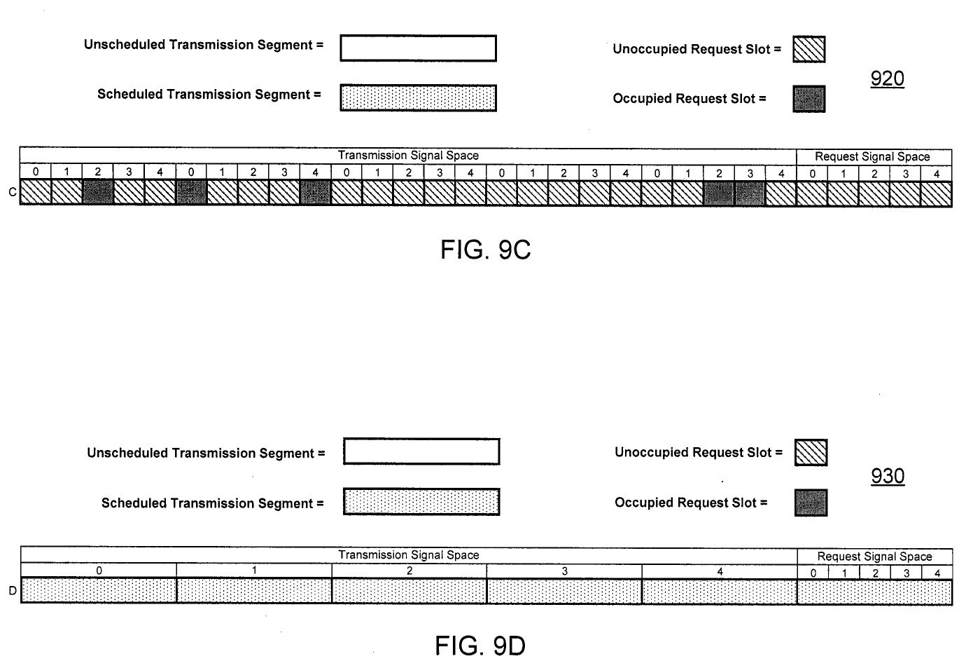

According to embodiments of the present invention, scheduled data transmissions may occupy the request signal space and requests may occupy the transmission signal space. That is, scheduled transmissions may be sent using the request signal space, and requests may be sent using the transmission signal space. Such techniques allow for flexible use of the signal space for scheduled and request transmissions. FIGS. 9A-9D are provide as illustrative examples.

FIG. 9A is an illustrative signal diagram showing communication medium 900 that includes a request signal space and a transmission signal space. A feedback signal space is not explicitly shown but may be implemented. For ease of illustration, shared communication medium 900 is organized as one continuous sequence of TDM time slots. Each TDM time slot occupies the entire bandwidth of the frequency channel, but only for a specific time duration. Thus, in this example the request signal space and the transmission signal space are separated using TDM multiplexing.

In FIG. 9A the TDM time slots are shown as being organized into a single frame (Frame A). Additional frames may follow. Frame A is partitioned to include five transmission segments (labeled as transmission segments 0 to 4) and five request segments (labeled as request segments 0 to 4) arranged in time sequentially. For ease of illustration, the symbols represented by each time slot are not shown. The number of symbols in each time slot, as well as the number of time slots in each frame, is variable. In some embodiments, such variables are determined and controlled by scheduler node 102.

When an access node, such as access nodes 104, 106, 108, and 110, requests a scheduled transmission, the access node sends a request utilizing a request opportunity. This is illustrated in FIG. 9A. In the example shown, three requests are sent in the request interval of Frame A. In this example, the requests sent in Frame A occupy request segments 1, 2, and 4. Merely by way of example, the requests shown in FIG. 9A may be sent as follows. Access node 104 may send the request in request segment 1, access node 106 may send the request in request segment 2, and access node 108 may send the request in request segment 4. Of course, an access node may also send multiple requests in the same frame. Thus, in an alternative example, all three of the requests shown in FIG. 9A may be sent by access node 104.

In some embodiments, scheduler node 102 may receive the requests and make assignments to assign each request to a transmission segment. Thus, in response to the requests, scheduler node 102 sends out assignment messages in a feedback signal space (not shown). The assignment is broadcast to access nodes 104, 106, 108, and 110 to inform the access nodes of the assignments made, so that each access node may correctly send data in the assigned transmission segment.

Each assignment message explicitly includes a pair of data: (1) an identifier for the request and (2) an identifier for the transmission segment associated with the request. Continuing with the example of FIG. 9A, the first assignment message may include the pair of data “REQ.A:1, SCH. X:0.” This indicates that the request sent in the request segment “REQ. A:1” (the request occupying request segment 1 of Frame A) has been assigned the scheduled transmission segment “SCH. X:0” (scheduled transmission segment 0 of Frame X). Here, Frame X represents a subsequent frame with a previously unscheduled transmission segment 0. The rest of the assignment messages follow a similar format. The second assignment message may include the pair of data “REQ. A:2, SCH. X:1.” The third assignment message may include the pair of data “REQ. A:4, SCH. X:2.”

As discussed previously, the entire request and assignment process may take place in an anonymous manner with respect to the identity of the access nodes. This is possible because each access node keeps track of the locations of the symbol-level requests it has sent and accepts only the assignments associated with its requests.

In the example of FIG. 9A, the assigned transmission segments are delayed in that the requests are sent in Frame A, but the transmission segments are assigned in Frame X, which may occur one or more frames after Frame A. Such a delay may, for example, be inherent in a system utilizing a request and assignment protocol or may be the result of a particular scheduling mode.

As will be discussed below, unoccupied transmission segments (for example unscheduled transmission segment 4 in Frame A) may be used for requests in accordance with embodiments of the invention. Such a technique allows for flexible and efficient use of transmission segments that do not become assigned as a result of specific symbol-level requests. For example, FIG. 9B shows a communication medium 910 that is similar to the shared communication medium of FIG. 9A. Shared communication medium 910 is organized as one continuous sequence of TDM time slots in a single frame (Frame B) and partitioned to include five transmission segments and five request segments. In this example, however, transmission segment 4 is occupied by a request rather than a scheduled transmission. For ease of illustration, transmission segment 4 is not explicitly labeled, but instead is shown as comprising a sequence of five TDM time slots (0 to 4). Because transmission segment 4 is not occupied by a scheduled transmission, transmission segment 4 is available to be occupied by requests sent by the access nodes. Utilizing unoccupied transmission segments for requests increases the number of request opportunities in a particular frame and thus decreases the probability of collision.

In some embodiments, the access nodes keep track of which transmission segments are assigned for scheduled transmissions in each frame. Thus, the access nodes know which transmission segments are not occupied and are thus available for sending requests. In the example of FIG. 9B, transmission segment 4 is shown comprising five TDM time slots that appear similar to request segments 0-4 in the request signal space. The TDM time slots in FIG. 9B that are not occupied by requests are shown as unoccupied request slots since these slots are available for sending requests. Although the TDM time slots in transmission segment 4 of FIG. 9B are shown as dividing into an integer number of request opportunities this is not required.

In some embodiments, the access nodes may randomly select a request opportunity in the request signal space or in an unoccupied transmission segment. In accordance with another embodiment, when an access node, such as access nodes 104, 106, 108, and 110, sends a symbol-level request, the access node may utilize a defined schedule to select a request opportunity from the available request opportunities. In this sense, the defined schedule “polls” each access node to send its request in the appropriate request opportunity. Here a request opportunity may comprise the request segments in the request signal space and the available TDM time slots in unoccupied transmission segments.

Generally speaking, a polled request has both advantages and disadvantages when compared to a contention request. One advantage is that there is no possibility of collision. This is because the defined schedule does not make the same request opportunity available for requests from more than one access node. A disadvantage of a polled request is that it may add latency. When an access node utilizing polled requests is ready to send a request, it might not be able to do so right away. Instead, the access node may have to wait for the next request opportunity according to the defined schedule.

In the example of FIG. 9B, one request is sent in unoccupied transmission segment 4 and three requests are sent in request segments 0, 2, and 3 of the request signal space. In one example, the requests shown in FIG. 9B may be sent as follows. Access node 104 may send the request in TDM time slot 1 of transmission segment 4, access node 106 may send the request in request segment 0, access node 108 may send the request in request segment 2, and access node 110 may send the request in request segment 3.

In some embodiments, scheduler node 102 may receive the requests and make assignments to assign each request to a transmission segment. Thus, in response to the requests, scheduler node 102 sends out assignment messages in a feedback signal space (not shown). The assignment is broadcast to access nodes 104, 106, 108, and 110 to inform the access nodes of the assignments made, so that each access node may correctly send data in the assigned transmission segment.

As explained previously, each assignment message may explicitly include a pair of data: (1) an identifier for the request and (2) an identifier for the transmission segment associated with the request. Thus, in the example of FIG. 9B, the first assignment message may include the pair of data “REQ. B:4:1, SCH. Y:0.” This indicates that the request sent in the request opportunity “REQ. B:4:1” (the request occupying TDM time slot 1 of transmission segment 4 of Frame B) has been assigned the scheduled transmission segment “SCH. Y:0” (scheduled transmission segment 0 of Frame Y). Here, Frame Y represents a subsequent frame with a previously unscheduled transmission segment 0. The rest of the assignment messages follow a similar format. The second assignment message may include the pair of data “REQ. B:0, SCH. Y:1.” The third assignment message may include the pair of data “REQ. B:2, SCH. Y:2.” The fourth assignment message may include the pair of data “REQ. B:3, SCH. Y:3.”

As discussed previously, the entire request and assignment process may take place in an anonymous manner with respect to the identity of the access nodes. This is possible because each access node keeps track of the locations of the symbol-level requests it has sent and accepts only the assignments associated with its requests.

FIG. 9C is an illustrative signal diagram showing a shared communication medium 920 according to an embodiment of the invention. In this example, none of the transmission segments are occupied by scheduled transmissions. As a result, all of the transmission segments are available for requests. Such a situation may occur, for example, when no scheduled transmission segments have been assigned as a result of specific symbol-level requests. Alternatively, such a situation may occur during initial system start up before any assignments have been made.

For ease of illustration, the transmission segments in FIG. 9C are not explicitly labeled but are shown as each comprising a sequence of five TDM time slots. As explained previously, the symbols represented by each time slot are not shown. Also, the number of symbols in each time slot, as well as the number of time slots in each transmission segment and in each frame, is variable.

In the example of FIG. 9C, five requests are sent, and each request is sent in the unoccupied transmission segments. The first request is sent in TDM time slot 2 of transmission segment 0, the second and third requests are sent in TDM time slots 0 and 4 of transmission segment 1, and the fourth and fifth requests are sent in TDM time slots 2 and 3 of transmission segment 4. In one example, the request signals shown in FIG. 9C may be sent as follows. Node 104 may send a request in TDM time slot 2 of transmission segment 0. Node 104 may also send a request in TDM time slot 0 of transmission segment 1. Node 106 may send a request in TDM time slot 4 of transmission segment 1. Node 108 may send a request in TDM time slot 2 if transmission segment 4, and node 110 may send a request in TDM time slot 3 of transmission segment 4. As explained previously, scheduler node 102 may receive the requests and make assignments to assign each request to a transmission segment.

FIG. 9D is an illustrative signal diagram showing a shared communication medium 930 according to an embodiment of the invention. In this example, all of the transmission segments are occupied by scheduled transmissions. The request signal space is also occupied by a scheduled transmission. Such a situation may occur, for example, when scheduler node 102 assigns all of the transmission segments in a particular frame for scheduled transmissions and also assigns the request signal space for one or more scheduled transmissions.

The shared communication medium 930 may be organized in a manner similar to that of FIGS. 9A-9C described previously. As shown in the example of FIG. 9D, no request opportunities are available in Frame D. Thus, Frame D does not include any requests. As such, access nodes, such as access nodes 104, 106, 108, and 110, cannot send requests for scheduled transmissions in Frame D. Such requests may be sent, however, in a subsequent frame with available request opportunities.

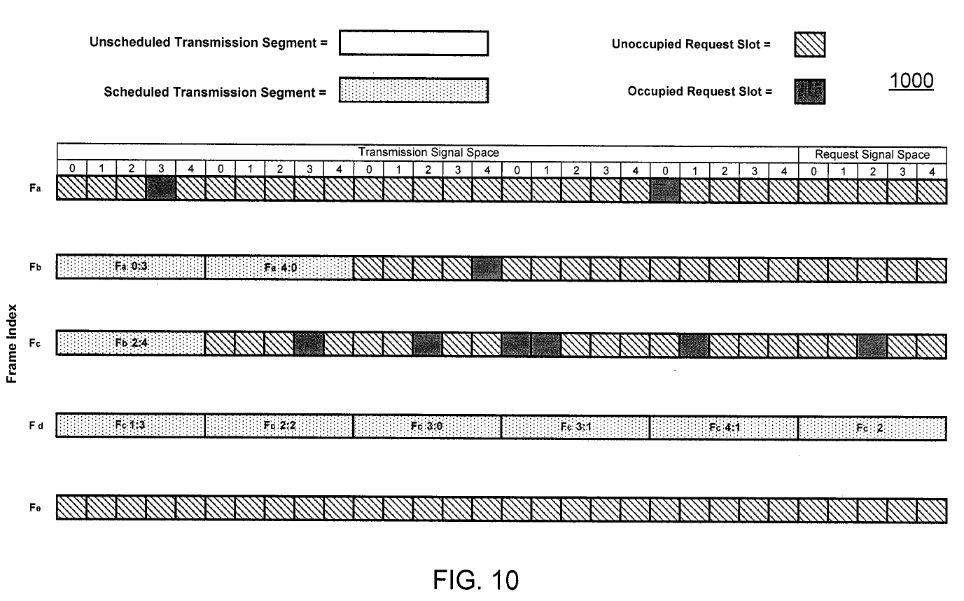

FIG. 10 is an illustrative signal diagram showing an implementation of the flexible assignment of scheduled and request transmissions, according to an embodiment of the invention. The figure shows a representation of shared communication medium 1000 that includes a request signal space and a transmission signal space. A feedback signal space is not explicitly shown in this figure but may also be implemented.

For ease of illustration, shared communication medium 1000 is organized as a continuous sequences of TDM time slots. Thus, in this example, the request signal space and the transmission signal space are separated using TDM multiplexing. The TDM time slots are shown as being organized into frames (Fa, Fb, Fc, Fd, and Fe). Additional frames may follow. Although Frames Fa, Fb, Fc, Fd, and Fe may occur consecutively in time, they are not necessarily successive. Instead, other frame(s) may exist between Frame Fa and Frame Fb, between Frame Fb and Frame Fc, between Frame Fc and Frame Fd, and between Frame Fd and Frame Fe. The number of frames between each of the frames illustrated in FIG. 10 may depend on the delay of the particular system or the particular scheduling mode.

In the example of FIG. 10, Frame Fa of shared communication medium 1000 includes no scheduled transmissions. This is similar to the example of FIG. 9C. In the example shown in FIG. 10, however, two requests are sent and each request is sent in an unoccupied transmission segment. The first request is sent in TDM time slot 3 of transmission segment 0, and the second request is sent in TDM time slot 0 of transmission segment 4. As explained previously, the transmission segments are not explicitly labeled in FIG. 10, but are shown as each comprising a series of five TDM time slots. Scheduler node 102 receives the requests and makes assignments to assign each request to a scheduled transmission segment. In the example of FIG. 10, the first request may be assigned transmission segment 0 of Frame Fb, and the second request may be assigned transmission segment 1 of Frame Fb. This is illustrated in FIG. 10.

As a result of the above assignments, Frame Fb of communication medium 1000 includes scheduled transmission segments 0 and 1. The remaining transmission segments (2 to 4), however, are not occupied by scheduled transmissions and are thus available for request opportunities. In the example shown, one request is sent in Frame Fb. The request is sent in TDM time slot 4 of transmission segment 3. Scheduler node 102 receives the request and makes an assignment. For example, the request may be assigned scheduled transmission segment 0 of Frame Fc. This is illustrated in FIG. 10.

Frame Fc includes scheduled transmission segment 0. The remaining transmission segments (1 to 4), however, are not occupied by scheduled transmissions and are thus available for request opportunities. In the example shown, six requests are sent in Frame Fc. The first request is sent in TDM time slot 3 of transmission segment 1, the second request is sent in TDM time slot 2 of transmission segment 2, the third and fourth requests are sent TDM time slots 0 and 1 of transmission segment 3, the fifth request is sent in TDM time slot 1 of transmission segment 4, and the sixth request is sent in request segment 2 of the request signal space. In the example of FIG. 10, the first request may be assigned transmission segment 0 of Frame Fd, the second request may be assigned transmission segment 1 of Frame Fd, the third request may be assigned transmission segment 2 of Frame Fd, the fourth request may be assigned transmission segment 3 of Frame Fd, and the fifth request may be assigned transmission segment 4 of Frame Fd. Thus, five of the six requests have been assigned a scheduled transmission segment in subsequent frame Fd. In accordance with one embodiment, the sixth request may be assigned the request signal space for a scheduled transmission. This is illustrated in FIG. 10, where the request signal space of Frame Fd is occupied by a scheduled transmission labeled as Fc 2 (assigned to the request occupying request segment 2 in Frame C). As illustrated in FIG. 10, all requests from Frame Fc are assigned scheduled transmissions in Frame Fd. As a result, no request opportunities are available in Frame Fd, and thus there are no scheduled transmissions in subsequent Frame Fe.

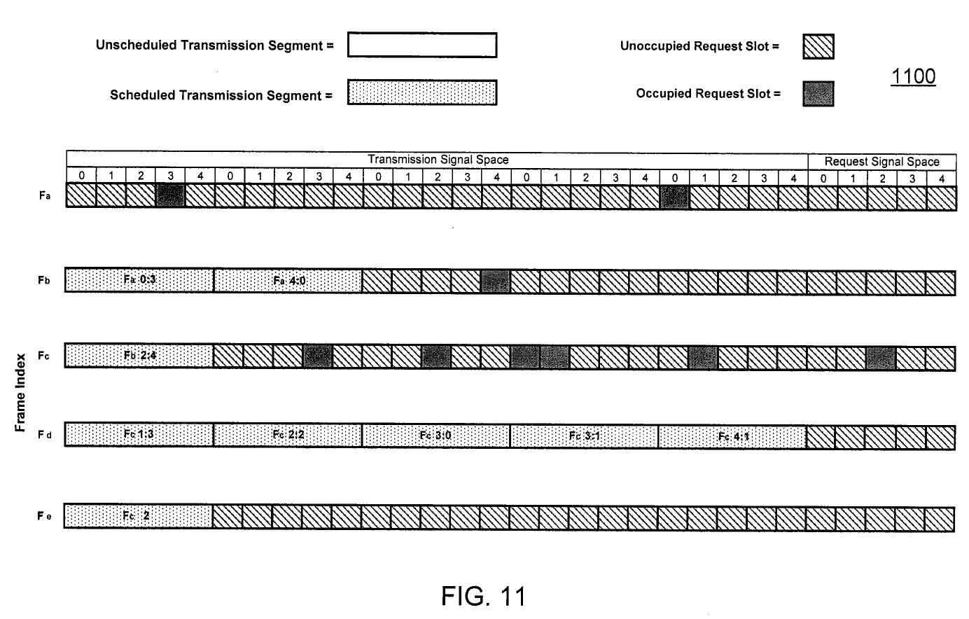

According to another embodiment, when all request segments in a particular frame are assigned, remaining unassigned requests may be assigned scheduled transmissions in subsequent frames, rather than utilizing the request signal space. This is illustrated in FIG. 11. Here, the sixth request in Frame Fc is assigned transmission segment 0 in Frame Fe. This ensures that request opportunities are available in Frame Fd. Such assignments are under control of scheduler node 102 and may depend on factors such as the overall utilization of the shared communication medium.

FIGS. 9A-9D, 10, and 11 illustrate examples of the flexible use of scheduled and request transmissions. Such examples are for illustrative purposes and are not meant to limit the scope of the present invention. One of ordinary skill in the art would recognize many other ways of efficiently utilizing a shared communication medium using the teachings provided herein. Also, although the shared communication medium illustrated in FIGS. 9A-9D, 10, and 11 is organized based on TDM, in other embodiments the communication medium may be organized based on FDM, CDM, and/or other multiplexing techniques. Additionally, the shared communication medium may include combinations of the above multiplexing techniques. Further, the requests and assignments illustrated in these figures are based on various scheduling modes, and some embodiments may utilize different scheduling modes.

Accordingly, the specification and drawings are to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for communicating using a shared communication medium involving a plurality of nodes, the method comprising:
(a) sending a first request over the shared communication medium from a first node in the plurality of nodes, the shared communication medium organized to include signal space comprising request signal space and transmission signal space, the request signal space and the transmission signal space having different locations within the signal space, wherein the request signal space includes request segments and the transmission signal space includes transmission segments, the first request occupying a portion of a transmission segment;
(b) receiving an assignment associating the first request with a transmission segment, the assignment taking into account location of the portion of the transmission segment within the transmission signal space; and
(c) from the first node, sending a data transmission in the transmission segment associated with the first request in accordance with the assignment.

2. The method of claim 1 wherein the portion of the transmission segment occupied by the first request is randomly selected by the first node.

3. The method of claim 1 wherein the portion of the transmission segment occupied by the first request is allotted to the first node according to a schedule.

4. The method of claim 1 further comprising:
(d) sending a second request over the shared communication medium from a second node in the plurality of nodes, the second request occupying a first request segment.

5. The method of claim 4 wherein the signal space is organized to include a plurality of frames, the second request occupying the first request segment of a first frame, the method further comprising:
(e) receiving a second assignment associating the second request with the request signal space of a second frame; and
(f) from the second node, sending a second data transmission in the request signal space of the second frame in accordance with the second assignment.

6. The method of claim 4 further comprising:
(e) receiving a second assignment associating the second request with a second transmission segment, the second assignment taking into account location of the first request segment within the request signal space; and
(f) from the second node, sending a second data transmission in the second transmission segment associated with the second request in accordance with the second assignment.

7. The method of claim 6 wherein the signal space is organized to include a plurality of frames, the first request occupying the portion of the transmission segment of a first frame and the second request occupying the first request segment of the first frame, and wherein the transmission segment associated with the first request is in a second frame and the second transmission segment associated with the second request is in a third frame.

8. A method for communicating using a shared communication medium involving a plurality of nodes including a first node and a second node, the method comprising:
(a) at the second node, receiving a first request over the shared communication medium from the first node, the shared communication medium organized to include signal space comprising request signal space and transmission signal space, the request signal space and the transmission signal space having different locations within the signal space, wherein the request signal space includes request segments and the transmission signal space includes transmission segments, the first request occupying a portion of a transmission segment;
(b) at the second node, making an assignment associating the first request with a transmission segment, the assignment taking into account location of the portion of the transmission segment within the transmission signal space, and sending a corresponding assignment message; and
(c) at the second node, receiving a data transmission from the first node in the transmission segment associated with the first request.

9. The method of claim 8 further comprising:
(d) at the second node, receiving a second request over the shared communication medium from a third node, the second request occupying a first request segment.

10. The method of claim 9 wherein the signal space is organized to include a plurality of frames, the second request occupying the first request segment of a first frame, the method further comprising:
(e) at the second node, making a second assignment associating the second request with the request signal space of a second frame; and
(f) at the second node, receiving a second data transmission from the third node in the request signal space of the second frame in accordance with the second assignment.

11. The method of claim 9 further comprising:
(e) at the second node, making a second assignment associating the second request with a second transmission segment, the second assignment taking into account location of the first request segment within the request signal space; and
(f) at the second node, receiving a second data transmission from the third node in the second transmission segment associated with the second request in accordance with the second assignment.

12. The method of claim 11 wherein the signal space is organized to include a plurality of frames, the first request occupying the portion of the transmission segment of a first frame and the second request occupying the first request segment of the first frame, and wherein the transmission segment associated with the first request is in a second frame and the second transmission segment associated with the second request is in a third frame.

13. An apparatus for communicating using a shared communication medium involving a plurality of nodes, comprising:
(a) a first node capable of sending a first request over the shared communication medium, the shared communication medium organized to include signal space comprising request signal space and transmission signal space, the request signal space and the transmission signal space having different locations within the signal space, wherein the request signal space includes request segments and the transmission signal space includes transmission segments, the first node capable of sending the first request in a portion of a transmission segment;
(b) wherein the first node is capable of obtaining an assignment associating the first request with a transmission segment, the assignment taking into account location of the portion of the transmission segment within the transmission signal space; and
(c) wherein the first node is capable of sending a data transmission in the transmission segment associated with the first request in accordance with the assignment.

14. The apparatus of claim 13 wherein the first node is capable of randomly selecting the portion of the transmission segment for the first request.

15. The apparatus of claim 13 wherein the first node is capable of selecting the portion of the transmission segment for the first request according to a schedule.

16. The apparatus of claim 13 further comprising:
(d) a second node capable of sending a second request over the shared communication medium, the second node capable of sending the second request in a first request segment.

17. The apparatus of claim 16 wherein the signal space is organized to include a plurality of frames, the second request occupying the first request segment of a first frame, wherein the second node is capable of obtaining a second assignment associating the second request with the request signal space of a second frame, and wherein the second node is cable of sending a second data transmission in the request signal space of the second frame in accordance with the second assignment.

18. The apparatus of claim 16 wherein the second node is capable of obtaining a second assignment associating the second request with a second transmission segment, the second assignment taking into account location of the second request within the request signal space, and wherein the second node is capable of sending a second data transmission in the second transmission segment associated with the second request in accordance with the second assignment.

19. The apparatus of claim 18 wherein the signal space is organized to include a plurality of frames, the first request occupying the portion of the transmission segment of a first frame and the second request occupying the first request segment of the first frame, and wherein the transmission segment associated with the first request is in a second frame and the second transmission segment associated with the second request is in a third frame.

20. An apparatus for communicating using a shared communication medium involving a plurality of nodes, comprising:
(a) a second node capable of receiving a first request over the shared communication medium from a first node, the shared communication medium organized to include signal space comprising request signal space and transmission signal space, the request signal space and the transmission signal space having different locations within the signal space, wherein the request signal space includes request segments and the transmission signal space includes transmission segments, the second node capable of receiving the first request in a portion of a transmission segment;
(b) wherein the second node is capable of making an assignment associating the first request with a transmission segment, the assignment taking into account location of the portion of the transmission segment within the transmission signal space, and sending a corresponding assignment message; and
(c) wherein the second node is capable of receiving a data transmission from the first node in the transmission segment associated with the first request.
